(19) United States
(12) Patent Application Publication
(10) Pub. No.: US 2018/0071172 A1
(43) Pub. Date: Mar. 15, 2018

(54) Automatic Pill Dispenser

(71) Applicant: Paul BROWN, Torrington, CT (US)

(72) Inventor: Paul BROWN, Torrington, CT (US)

(21) Appl. No.: 15/706,617

(22) Filed: Sep. 15, 2017

Related U.S. Application Data
(60) Provisional application No. 62/394,921, filed on Sep. 15, 2016.

(51) Int. Cl. A61J 7/04

(52) U.S. Cl. CPC A61J 7/0481; G08B 21/24; A61J 7/0436

(57) ABSTRACT

Disclosed is an automatic pill dispenser comprising a base, a cover, and a clock. The base comprises upper, lower and middle portions. The upper portion comprises an upper portion top surface, an upper portion bottom surface, an upper portion edge, a plurality of container cavities, and a plurality of trigger posts. The middle portion comprises a middle portion wall, a middle portion top, and a middle portion bottom. The container cavity bottom is configurable between an open configuration and a closed configuration. In the open configuration the cavity bottom is open such that the upper portion top surface is in communication with the upper portion bottom surface. The clock comprises a clock operation module, a set of clock hands, and a hand post. The set of clock hands comprises a minute hand, and an hour hand. The hand post connects the clock operation module to the set of clock hands.

### CROSS-REFERENCE TO RELATED APPLICATIONS

This application claims priority to U.S. Provisional Application No. 62/394,921, filed Sep. 15, 2016, which is hereby incorporated by reference in its entirety.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates generally to an article for dispensing pills and more particularly to an article for automatically dispensing pills.

Typically as people age, they encounter situations where they are required to take more and more medications. These medications typically come in the form of pills, some of which must be taken at multiple times a day at different times. This creates problems in that depending on the different ailments of the person, the number of pills needed to be taken may be upwards of up to eight to ten pills, three times a day which may be hard to keep organized. This situation is further complicated by the fact that as people get older, they easily become confused and generally have a difficult time keeping track of tasks they need to do. One device that was developed to try and overcome this problem is a pill box which is segmented into multiple compartments which represent days of the week and times of the day. Unfortunately however, this pill box must be constantly monitored as it merely groups the pills into piles that need to be taken and does not provide a reminder to the person. Accordingly, while the pill box helps in putting the medication in one place, there is no way to inform the person that a medication is due.

### BRIEF SUMMARY OF THE INVENTION

An object of the present invention is a pill timer and dispenser system comprising a base, a cover, and a clock. The base comprises an upper portion, lower portion and a middle portion. The upper portion comprises an upper portion top surface, an upper portion bottom surface, an upper portion edge, a plurality of container cavities, and a plurality of trigger posts. The middle portion comprises a middle portion wall, a middle portion top, and a middle portion bottom. The upper portion edge extends along the upper portion. Each of the plurality of container cavities comprises a container cavity bottom. Each of the plurality of trigger posts is associated with a respective container cavity. The container cavity bottom is configurable between an open configuration and a closed configuration. In the open configuration the cavity bottom is open such that the upper portion top surface is in communication with the upper portion bottom surface. The middle portion wall defines a middle portion cavity. The middle portion supports the upper portion. The clock comprises a clock operation module, a set of clock hands, and a hand post. The set of clock hands comprises a minute hand, and an hour hand. The hand post connects the clock operation module to the set of clock hands.

In another embodiment of the present invention, the clock further comprises an alarm, and an alarm acknowledgement switch.

In yet another embodiment of the present invention, the pill timer and dispenser system further comprises a locking mechanism, wherein the locking mechanism secures the cover.

In another embodiment of the present invention, the locking mechanism is a child-resistant buckle.

In yet another embodiment of the present invention, the clock is an analog clock.

In another embodiment of the present invention, the clock is a digital clock.

In yet another embodiment of the present invention, the pill timer and dispenser system further comprises an external container article. The external container article comprises an article carrying cup, and an article container arm.

In another embodiment of the present invention, the cover further comprises a cover center portion and the external container article further comprises an arm end portion. The cover center portion is movably associated with the arm end portion.

### BRIEF DESCRIPTION OF THE SEVERAL VIEWS OF THE DRAWING

The advantages and features of the present invention will be better understood as the following description is read in conjunction with the accompanying drawings, wherein:

FIG. 1 is a top down view of the Pill Timer/Dispenser System (PTDS), in accordance with one embodiment of the invention.

FIG. 2 is a side view of the PTDS of FIG. 1.

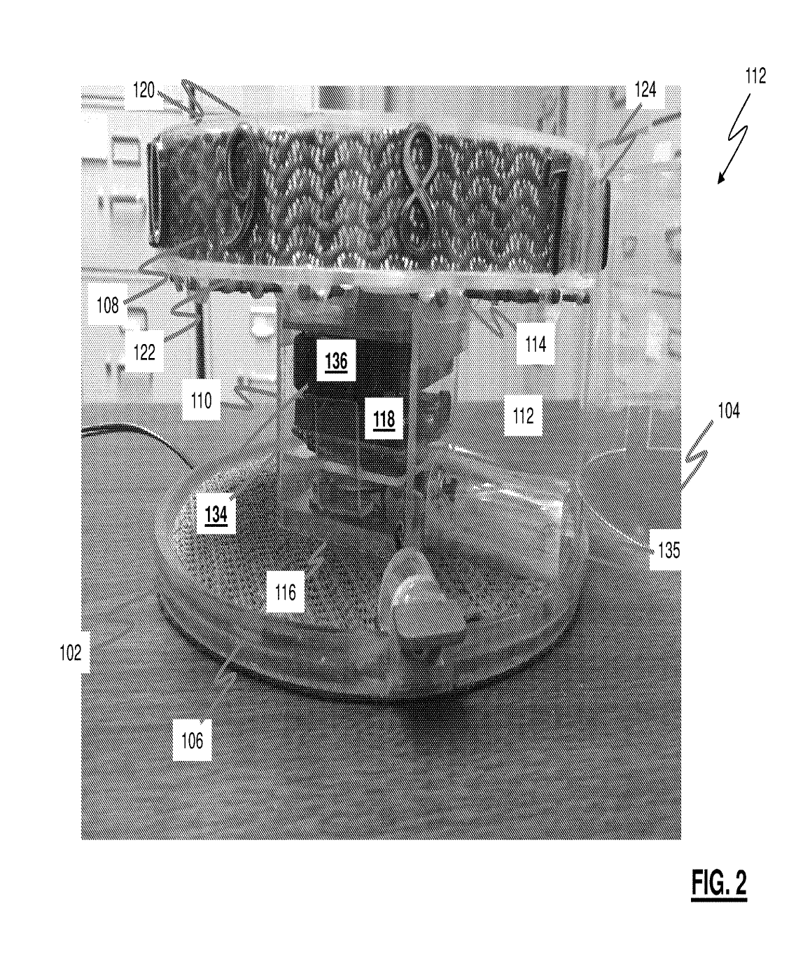

FIG. 3 is a top down view of the upper portion of the PTDS of FIG. 1.

FIG. 4 is a side view of the PTDS of FIG. 1.

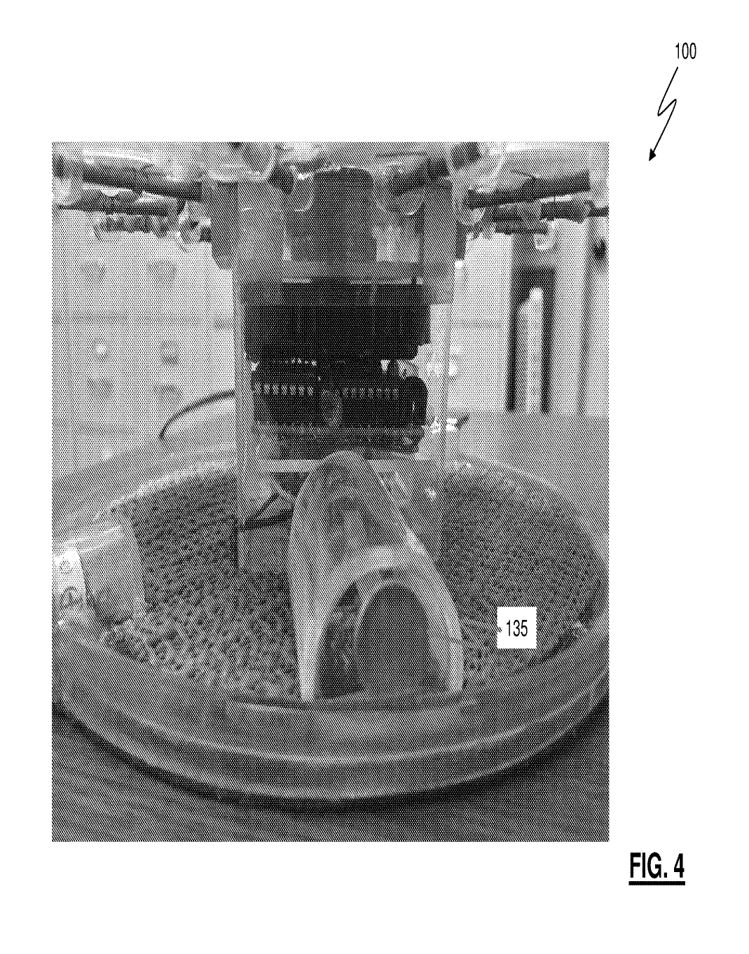

FIG. 5 is a side view of the PTDS of FIG. 1.

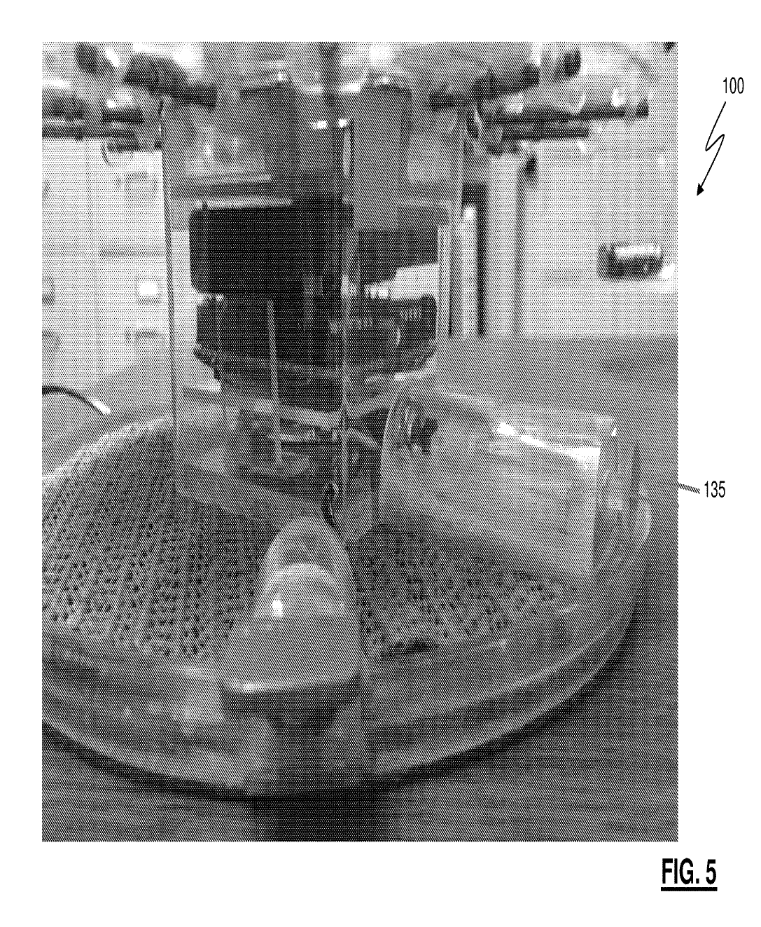

FIG. 6 is a perspective view of the PTDS, in accordance with one embodiment of the invention.

FIG. 7 is a perspective view of the PTDS, in accordance with one embodiment of the invention.

FIG. 8 is a perspective view of the PTDS, in accordance with one embodiment of the invention.

FIG. 9 is a perspective view of the PTDS, in accordance with one embodiment of the invention.

### DETAILED DESCRIPTION OF THE INVENTION

As disclosed herein with regards to an exemplary embodiment, a novel pill timer/dispenser system (PTDS) 100 is provided. Referring to the Figures, the PTDS 100 includes a PTDS base 102 and a PTDS cover 104, wherein the PTDS base 102 includes a lower portion 106 and an upper portion 108 separated by a middle portion 110 such that the upper portion 108 is supported by the middle portion 110. The middle portion 110 includes a middle portion wall 112 which includes a middle portion top 114 and a middle portion bottom 116, wherein the middle portion wall 112 defines a middle portion cavity 118. The upper portion 108 is circular in shape and includes an upper portion top surface 120, an upper portion bottom surface 122 and an upper portion edge 124 which extends along the circumference of the upper portion 108.

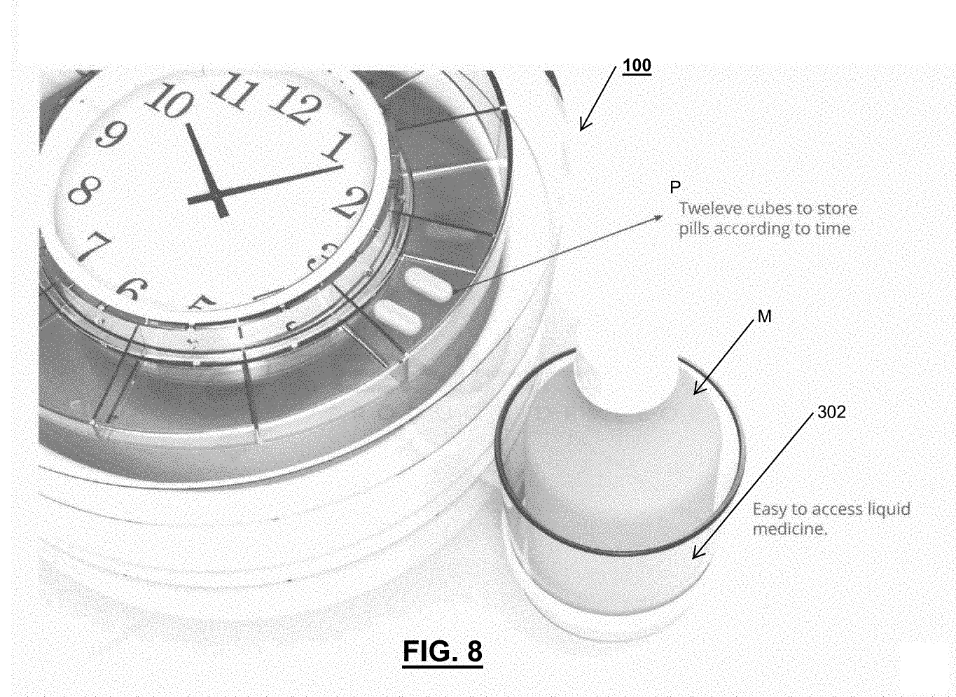

Additionally, the upper portion 108 defines a plurality of container cavities 126 each having a container cavity bottom 128. It should be appreciated that the container cavities 126 are distributed circumferentially along and proximate to the upper portion edge 124 and are arranged to resemble the time elements of a clock. It should be appreciated that for each container cavity 126, the container cavity bottom 128 is configurable between a first configuration and a second configuration, wherein when in the first configuration the cavity bottom 128 is closed to enclose the bottom portion of the container cavity 126 (as illustrated in FIG. 8) and when in the second configuration the cavity bottom 128 is open such that the upper portion top surface 120 is communicated with the upper portion bottom surface 122.

The PTDS 100 includes an analog clock 134 having a clock operation module 136 connected to a set of clock hands 138 via a hand post 140, wherein the analog clock 134 includes a clock operation module 136 which contains the components necessary to make the analog clock 134 operate such that the set of clock hands 138 rotate about an axis defined by the hand post 140. It should be appreciated that the clock operation module 136 is located within the middle portion cavity 118 such that the hand post 140 extends out of the middle portion top 114 and into the upper portion 108. Additionally, the set of clock hands 138 are attached to the hand post 140 such that the set of clock hands 138 are parallel with the upper portion top surface 120, wherein the upper portion top surface 120 acts like a clock face for the analog clock 134.

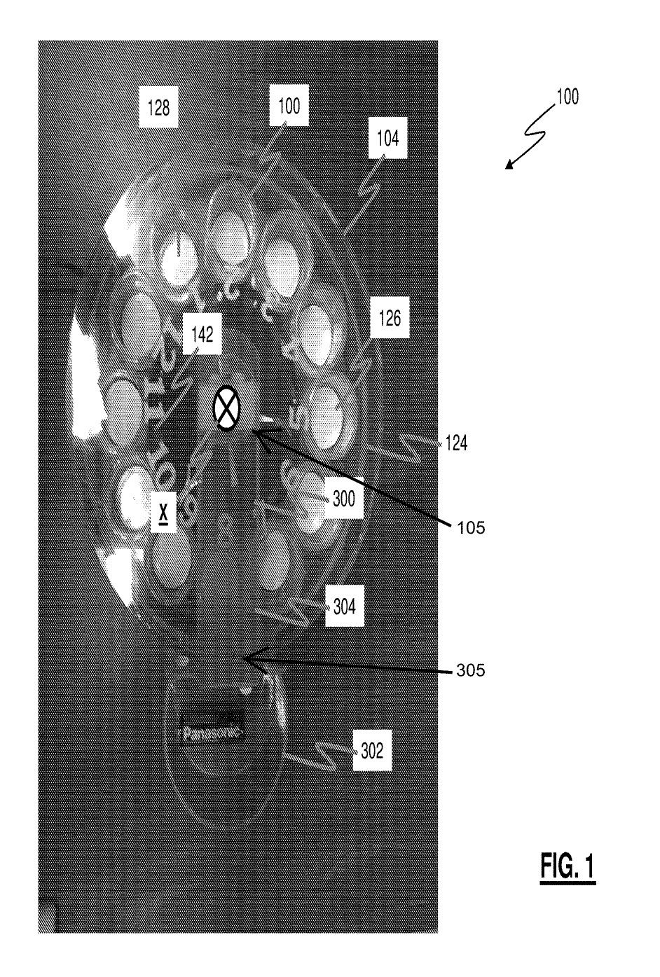

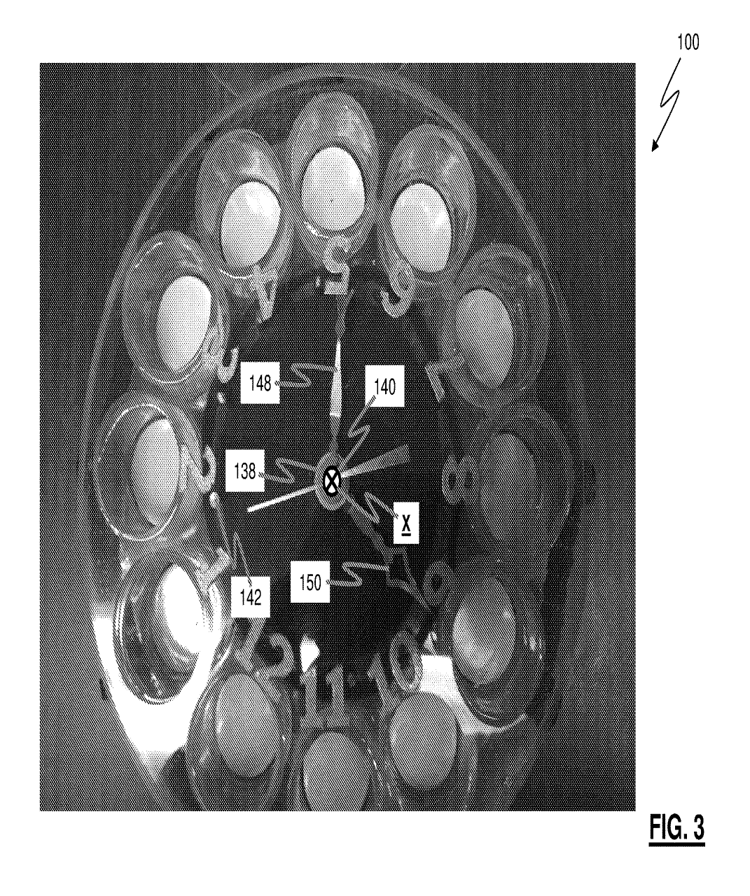

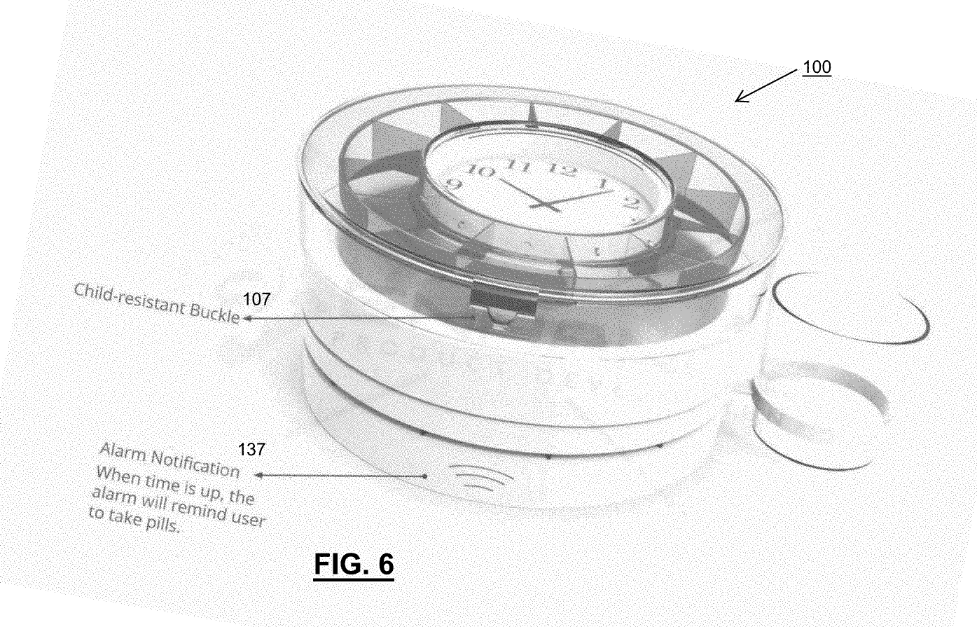

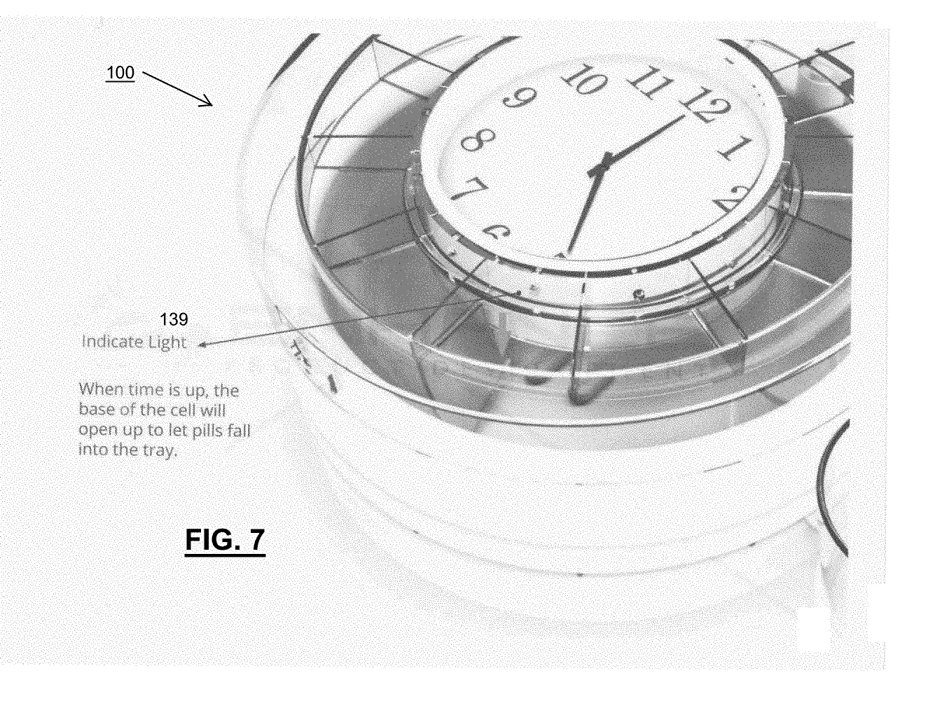

It should also be appreciated that the upper portion 108 includes a plurality of trigger posts 142, wherein the plurality of trigger posts 142 are configured such that one trigger post 142 of the plurality of trigger posts 142 is located proximate one container cavity 126 of the plurality of container cavities 126. Each of the trigger posts 142 is associated with the container cavity bottom 128 of the container cavity 126 of which the trigger post 142 is adjacent. Additionally, each of the trigger posts 142 is configurable between an active configuration and an inactive configuration, where when in the inactive configuration the container cavity bottom 128 is configured into the first configuration and when in the active configuration the container cavity bottom 128 is configured into the second configuration. Furthermore, the set of clock hands 138 includes a minute hand 148 and an hour hand 150, wherein as the set of clock hands 138 rotate about the axis X (shown in FIG. 1 and FIG. 3), the minute hand 148 contacts each of the trigger posts 142 to cause the container cavity bottom 128 proximate the trigger post 142. It should be appreciated that numbers are located adjacent each of the container cavities 126 to correspond to the clock. For example, the first container cavity 126 has the number 1 next to it to symbolize 1 o'clock, the second container cavity 126 has the number 2 next to it to symbolize 2 o'clock and so on. Additionally, it should be appreciated that the analog clock 134 is programmable to set alarms 137 to go off at various desired times, wherein the alarms 137 may be audio, vibration and/or light 139 (flashing or solid), as shown in FIG. 6 and FIG. 7. The present invention is not limited to embodiments shown in the figures. For example, the figures provide an embodiment that has twelve container cavities 126. However, embodiments may have any number of container cavities 126, such as, twenty-four container cavities 126, which corresponds to every half hour for a twelve hour clock or every hour for a twenty-four hour clock.

The PTDS 100 includes an alarm acknowledgement switch 135 which when depressed deactivates the alarm. Additionally, the PTDS 100 may include an external container article 300 having an article carrying cup 302 and an article container arm 304, wherein the external container article 300 is configured to movably associate with the PTDS cover 104. In one embodiment, the PTDS cover 104 includes a cover center portion 105 and the external container article 300 includes an arm end portion 305 that are configured to movably associate with each other such that the external container article 300 is positionable anywhere about the circumference of the PTDS cover 104. It should be appreciated that the external container article 300 may be for medicines that may not fit into the container cavities 126, such as bottles for liquid medicines. For example, as shown in FIG. 8, if a liquid medicine has to be taken at 10 o'clock, the bottle B of medicine may be placed in the article carrying cup 302 and the external container article 300 may be associated with the PTDS cover 104 such that the article carrying cup 302 is located proximate the position on the circumference of the PTDS cover 104 that correlates with 10 o'clock.

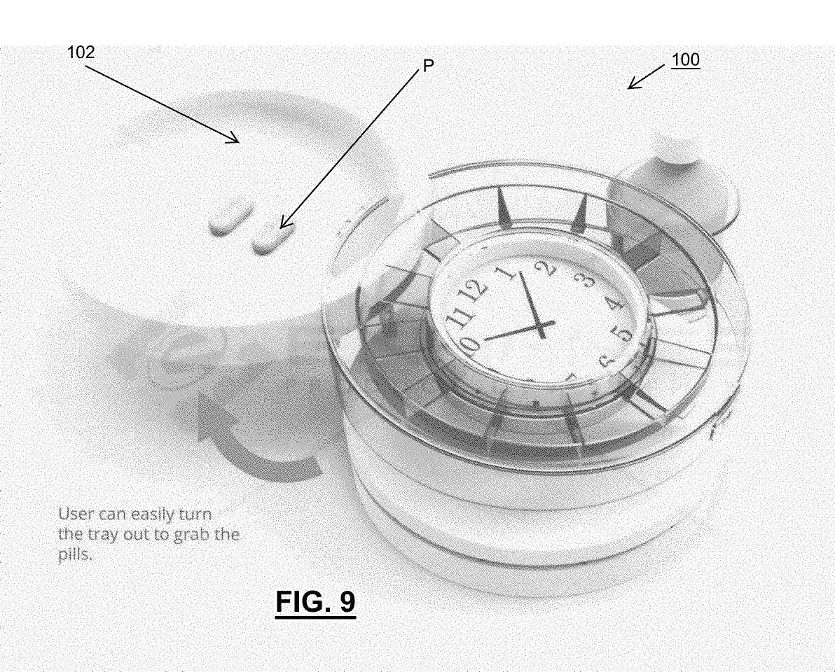

In accordance with one embodiment of the invention, the PTDS 100 operates as follows. The user separates and groups the pills/medication P that the user needs to take during a 12 hour period. For example, the user may create three groups of pills P that need to be taken at 8 am, 12 pm and 4 pm, respectively. The group of pills P that need to taken at 8 am are located within the container cavity 126 corresponding to the 8 o'clock position on the analog clock, the group of pills P that need to taken at 12 pm are located within the container cavity 126 corresponding to the 12 o'clock position on the analog clock and the group of pills P that need to taken at 4 pm are located within the container cavity 126 corresponding to the 4 o'clock position on the analog clock. When the clock strikes 8 am, the minute hand 148 contacts the trigger post 142 corresponding to the 8 o'clock container cavity 126, thereby causing the trigger post 142 to be configured from the inactive configuration into the active configuration. This cause the container cavity bottom 128 of the container cavity 126 corresponding to 8 o'clock to be configured from the first configuration into the second configuration. Accordingly, the container cavity bottom 128 will open up and the pills P contained within the container cavity 126 will drop onto the PTDS base 102 and an alarm (as set) will sound informing the user that it is time to take the pills P that dropped onto the PTDS base 102, as depicted in FIG. 9. A user may move the PTDS base 102 to access the pills P, as the PTDS base 102 may be configured to have a swivel means to allow the PTDS base 102 to rotate. Alternatively, the PTDS base 102 may be configured to be a drawer, whereby the PTDS base 102 slides out.

It should be appreciated that the invention may be implemented using a digital clock as well. In this instance, the digital clock may be electrically connected to the trigger posts 142 and have an alarm configurable to be set for a specific time. When the alarm on the clock is activated at a specific time, the clock would electrically cause the container cavity bottom of the specific container cavity pertaining to the specific time to open up and the pills P contained within the container cavity will drop onto the PTDS base 102, as depicted in FIG. 9.

In accordance with one embodiment of the invention, the PTDS 100 further comprises a locking mechanism 107, as shown in FIG. 6. The locking mechanism 107 secures the PTDS cover 104 to prevent access to medication in the PTDS 100 by, for example, children. The locking mechanism 107 may be a child-resistant buckle.

In accordance with one embodiment of the invention, the PTDS 100 operates on batteries. In accordance with another embodiment of the invention, the PTDS 100 utilizes a wired electrical connection.

We/I Claim:

1. A pill timer and dispenser system comprising:
a base; wherein the base comprises:
an upper portion; wherein the upper portion comprises:
an upper portion top surface;
an upper portion bottom surface;
an upper portion edge; wherein the upper portion edge extends along the upper portion;
a plurality of container cavities; wherein each of the plurality of container cavities comprises a container cavity bottom; and,
a plurality of trigger posts;
wherein each of the plurality of trigger posts is associated with a respective container cavity;
wherein the container cavity bottom is configurable between an open configuration and a closed configuration;
wherein in the open configuration the cavity bottom is open such that the upper portion top surface is in communication with the upper portion bottom surface; and,
a lower portion; and,
a middle portion; wherein the middle portion comprises:
a middle portion wall; wherein the middle portion wall defines a middle portion cavity;
a middle portion top; and,
a middle portion bottom;
wherein the middle portion supports the upper portion; and,
a cover; and,
a clock; wherein the clock comprises:
a clock operation module;
a set of clock hands; wherein the set of clock hands comprises:
a minute hand; and,
an hour hand; and,
a hand post;
wherein the hand post connects the clock operation module to the set of clock hands.

2. The pill timer and dispenser system of claim 1, wherein the clock further comprises:
an alarm; and,
an alarm acknowledgement switch.

3. The pill timer and dispenser system of claim 2 further comprising a locking mechanism, wherein the locking mechanism secures the cover.

4. The pill timer and dispenser system of claim 3, wherein the locking mechanism is a child-resistant buckle.

5. The pill timer and dispenser system of claim 4, wherein the clock is an analog clock.

6. The pill timer and dispenser system of claim 4, wherein the clock is a digital clock.

7. The pill timer and dispenser system of claim 1, further comprises:
an external container article, wherein the external container article comprises:
an article carrying cup; and,
an article container arm.

8. The pill timer and dispenser system of claim 7, wherein the cover further comprises:
a cover center portion; and, wherein the external container article further comprises:
an arm end portion; and, wherein the cover center portion is movably associated with the arm end portion.

9. The pill timer and dispenser system of claim 8 further comprising a locking mechanism, wherein the locking mechanism secures the cover.

10. The pill timer and dispenser system of claim 9, wherein the locking mechanism is a child-resistant buckle.

11. The pill timer and dispenser system of claim 10, wherein the clock is an analog clock.

12. The pill timer and dispenser system of claim 10, wherein the clock is a digital clock.
